(19) United States
(12) Patent Application Publication
(10) Pub. No.: US 2020/0211191 A1
(43) Pub. Date: Jul. 2, 2020

(54) METHOD AND SYSTEM FOR DETECTING DISORDERS IN RETINAL IMAGES

(71) Applicant: Sigtuple Technologies Private Limited, Bangalore (IN)

(72) Inventor: Ameya JOSHI, Mumbai (IN)

(73) Assignee: Sigtuple Technologies Private Limited, Bangalore (IN)

(21) Appl. No.: 15/753,112

(22) PCT Filed: Nov. 27, 2017
(86) PCT No.: PCT/IB2017/057405

§ 371 Date: Feb. 15, 2018

(30) Foreign Application Priority Data
Jan. 27, 2017 (IN) 201741003144

(51) Int. Cl. G06T 7/00; G06T 7/44; G06T 7/33

(52) U.S. Cl. CPC G06T 7/0014; G06T 7/44; G06T 7/337; G06T 2207/30041; G06T 2207/20081; G06T 2207/30096; G06T 2207/30204; G06T 2207/20084; G06T 2207/10101

(57) ABSTRACT

The present disclosure discloses a method and system for detecting disorders in retinal images. The method comprises, receiving one or more retinal images. Then, identifying one or more gross pathologies and extracting one or more patches around the one or more gross pathologies. Further, assigning confidence value to each of the one or more patches and classifying each of the one or more patches as belonging to a label of the set of labels. Further, computing a histogram for each label of the set of labels. Further, generating, a confidence vector for the corresponding retinal image. Further, generating a feature vector by combining the confidence vector generated for each of the one or more retinal images. A value of the feature vector determines the presence and grade of disorder.

### FIELD OF THE DISCLOSURE

The present subject matter relates to retinal disorders. The present subject matter relates more particularly, but not exclusively to a system and a method for detecting disorders in retinal images.

### BACKGROUND

Disorders related to eye of a subject have to be detected at earlier stages in order to prevent the disorders from posing a threat to eye sight. Disorders like Diabetic Retinopathy (DR) and Diabetic. Macular Edema (DME) have become leading cause of vision impairment and blindness in the subject. These disorders do not exhibit early warnings and as a result, the existing systems do not identify the disorders at the early stage. However, it is highly desired that the disorders have to he detected in time. Ophthalmologists diagnose eye related disorders with the help of retinal images. The retinal images may be fundus images or Optical Coherence Tomography (OCT) scans. The disorders are detected by the presence of gross pathologies in the retinal images.

Retinal specialists clinically evaluate the retinal images to detect the presence and location of the gross pathologies for detecting the disorders. Retinal image analysis systems are used for evaluating the retinal images. Fundus images represent an image of fundus region of the eye, whereas OCT scans are capable of imaging the layers of the retina beneath the surface of the retina. A few retinal abnormalities or disorders can be predominantly analyzed using fundus images alone and a few other abnormalities or disorders can be analyzed using OCT scans alone. A few abnormalities or disorders may require both fundus images and OCT scans for analysis. Existing retinal image analysis systems are incapable of combining and correlating the analysis carried out using fundus images and OCT scans. As the existing retinal images analysis systems do not consider both the fundus images and OCT scans for analysis, the existing systems may not provide accurate data for study of disorders.

Existing retinal image analysis systems analyze the disorders using either fundus images or OCT scans. The existing systems do not detect the presence of disorder using multiple images (views) of the eye. The existing systems extract random patches from a retinal image, to carry out analysis. Only few patches of the extracted random patches may comprise the actual region of interest over which the analysis has to be carried out. Thus, analysis is carried out over many random patches which may not contain the region of interest, thereby resulting in redundant data and reducing the efficiency.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In one embodiment, the present disclosure discloses a method for detecting disorders in retinal images. The method comprises receiving, by a disorder detection system, one or more retinal images, and identifying, one or more gross pathologies in each of the one or more retinal images. Each of the one or more gross pathologies is associated with a corresponding set of labels. The method further comprises extracting, one or more patches based on each of the one or more gross pathologies in a corresponding retinal image of the one or more retinal images. Further, the method comprises assigning a confidence value to each of the one or more patches in the corresponding retinal image of the one or more retinal images, for indicating a probability of each of the one or more patches belonging to each label of the corresponding set of labels, classifying, each of the one or more patches, into a label from the corresponding set of labels based on the corresponding confidence value, generating a confidence histogram for each of the classified labels for the corresponding retinal image of the one or more retinal images. The confidence histogram comprises the confidence value associated with each of the one or more patches for belonging to the corresponding label. The method further comprises, determining, a confidence vector for the corresponding retinal image, by concatenating the confidence histogram generated for each of the classified labels, assigning, a weight to the confidence vector generated for each of the one or more retinal images, based on a pre-learnt weight. Lastly the method comprises determining, a value of a feature vector, based on the confidence vector generated for each of the one or more retinal images and the corresponding weight assigned, for detecting the disorder in the one or more retinal images.

In an embodiment, the present disclosure relates to a disorder detection system for detecting disorders in retinal images. The disorder detection system comprises a processor and a memory. The memory is communicatively coupled with the processor. The processor is configured to receive one or more retinal images, identify, one or more gross pathologies in each of the one or more retinal images. Each of the one or more gross pathologies is associated with a corresponding set of labels. The processor further extracts, one or more patches based on each of the one or more gross pathologies in a corresponding retinal image of the one or more retinal images. Then, the processor assigns a confidence value to each of the one or more patches in the corresponding retinal image of the one or more retinal images, for indicating a probability of each of the one or more patches belonging to each label of the corresponding set of labels. Furthermore, the processor classifies, each of the one or more patches into a label from the corresponding set of labels based on the corresponding confidence value. Thereafter, the processor generates, a confidence histogram for each of the classified labels for the corresponding retinal image of the one or more retinal images. The confidence histogram comprises the confidence value associated with each of the one or more patches for belonging to the corresponding label. The processor further determines, a confidence vector for the corresponding retinal image, by concatenating the confidence histogram generated for each of the classified label. Then the processor assigns a weight to the confidence vector generated for each of the one or more retinal images, based on a pre-learnt weight. Lastly, the processor determines, a value of a feature vector, based on the confidence vector generated for each of the one or more retinal images and the corresponding weight assigned, for detecting the disorder in the one or more retinal images.

The foregoing summary is illustrative only and is not intended to be in any way limiting In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, will best he understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 shows a block diagram illustrative of an environment for detecting disorders in retinal images, in accordance with some embodiments of the present disclosure;

FIG. 2 shows an exemplary block diagram of a disorder detection system for detecting disorders in retinal images, in accordance with some embodiments of the present disclosure;

FIG. 3 shows an exemplary flowchart illustrating method steps for detecting disorders in retinal images, in accordance with some embodiments of the present disclosure;

FIG. 4 shows an exemplary representation of detecting disorders using two retinal images in accordance with some embodiments of the present disclosure; and

FIG. 5 shows a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below, it should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus preceded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure relate to a method and system for detecting disorders in one or more retinal images. The system receives the one or more retinal images. The system identifies one or more gross pathologies and extracts one or more patches around the one or more gross pathologies. Further, the system assigns a confidence value to each of the one or more patches and classifies each of the one or more patches to a label of a set of labels. Further, the system computes a histogram for each label of the set of labels and a confidence vector is generated for the corresponding retinal image. Further, the system generates a feature vector by combining the confidence vector generated for each of the one or more retinal images. A value of the feature vector determines the presence and grade of disorder. Thus, the disorder detection system provides an efficient method for detecting disorders using the one or more retinal images. The one or more retinal images may be of a subject. In an embodiment, the subject may be a patient or any other person.

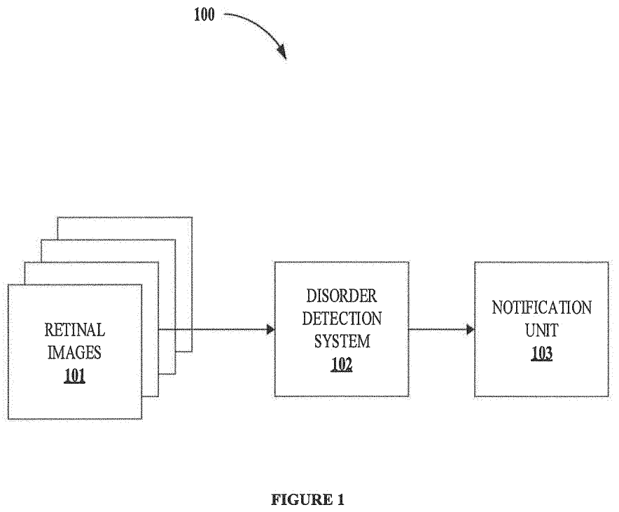

FIG. 1 shows a block diagram illustrative of an environment 100 for detecting disorders in the one or more retinal images. The environment 100 comprises one or more retinal images 101, a disorder detection system 102 and a notification unit 103. The one or more retinal images 101 are provided as input to the disorder detection system 102. The disorder detection system 102 receives the one or more retinal images 101 and processes the one or more retinal images 101 in order to determine presence of the disorder. In an embodiment, one or more gross pathologies may refer to macroscopic manifestations or macroscopic pathologies of the disorders in organs, tissues or body cavities. The one or more gross pathologies may be irregularities, abrupt structures, and abnormalities present in the one or more retinal images 101. Presence of the one or more gross pathologies in the one or more retinal images 101 may be indicative of presence of a particular disorder. For an instance, in case of Diabetic Macular Edema (DME), the disorder is determined by the presence of hard exudates on a surface of a fundus image and presence of fluid filled regions in Optical Coherence Tomography (OCT) scans.

Further, the disorder detection system 102, extracts one or more patches based on the one or more gross pathologies identified. Further, the disorder detection system 102 classifies the one or more patches into a label of the set of labels, indicative of the one or more gross pathologies. Further, a histogram is computed for each label of the set of labels. A confidence vector is computed for each image of the one or more retinal images 101. Then, a feature vector, is computed using the confidence vectors, computed for each image of the one or more retinal images 101. The feature vector is processed to determine the presence of a disorder in the one or more retinal images 101. The determined disorder is provided to the notification unit 103, which may provide an indication of the determined disorder to a clinician or any person analyzing the one or more one or more retinal images 101.

In an embodiment, the one or more retinal images 101, may include, but are not limited to a fundus image, an Optical Coherence Tomography (OCT) scan or any kind of retinal images used for analysis of retinal disorder. OCT may be in the form of a video. Image frames are extracted from the video and used for the purpose of analysis. In one implementation, the one or more retinal images 101 may be extracted from inputs including, but not limited to, an image, video, live images and the like. The formats of the type of one or more retinal images 101 may be one of, but are not limited to Resource Interchange File Format (RIFF), Joint Photographic Experts Group (HPEG/JPG), BitMaP (BMP), Portable Network Graphics (PNG), Tagged Image File Format (TIFF), Raw image files (RAW), Digital Imaging and Communication (DICOM), Moving Picture experts group (MPEG), MPEG-4 Part 14 (MP4), etc.

In an embodiment, the notification unit 103 may be used to notify the detected disorder to a clinical specialist examining the one or more retinal images 101. The notification unit 103, may include, but are not limited to a display device, a report generation device or any other device capable of providing a notification. In an embodiment, the notification unit 103 may be a part of the disorder detection system 102 or may be associated with the disorder detection system 102.

In an embodiment, the display device may be used to display the disorder detected by the disorder detection system 102. The display device may be one of, but not limited to, a monitor, a Liquid Crystal Display (LCD), a Light Emitting Diode (LED) display and/or any other module present which is capable of displaying the disorder.

In an embodiment, the report generation device may be used to generate a report comprising details of the disorder detected by the disorder detection system 102.

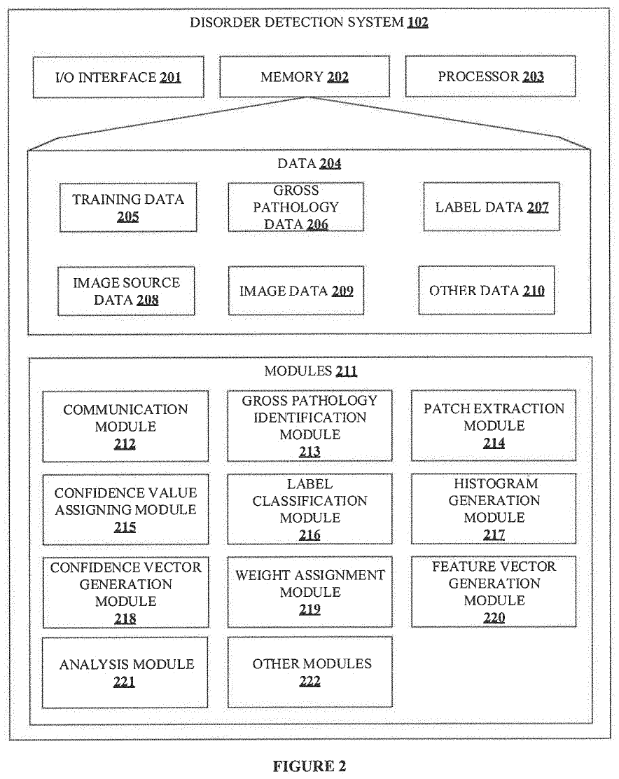

FIG. 2 shows an exemplary block diagram of a disorder detection system 102 for detecting disorders in the one or more retinal images 101 in accordance with some embodiments of the present disclosure. The disorder detection system 102 may include at least one processor 203 and a memory 202 storing instructions executable by the at least one processor 203. The processor 203 may comprise at least one data processor for executing program components for executing user or system-generated requests. The memory 202 is communicatively coupled to the processor 203. The disorder detection system 102 further comprises an Input/Output (I/O) interface 201. The I/O interface 201 is coupled with the processor 203 through which an input signal or/and an output signal is communicated. In an embodiment, the interface 201 provides the one or more retinal images 101 to the disorder detection system 102. In another embodiment, the I/O interface 210 couples the notification unit 103 to the disorder detection system 102.

In an embodiment the processor 203 may implement neural networks method for analyzing the one or more retinal images 101. The neural networks may implement any existing neural networks methodologies. The neural networks method may comprise, but are not limited to pre-trained statistical models or machine learning models.

In an embodiment, data 204 may be stored within the memory 202. The data 204 may include, for example, training data 205, gross pathology data 206, label data 207, image source data 208, image data 209 and other data 210.

In an embodiment, the pre-trained statistical models or machine learning models may be trained to analyze the retinal image using the training data 205. The training data 205 comprises the one or more retinal images. Few retinal images among the one or more retinal images may include one or more gross pathologies. In an embodiment, for training the disorder detection system 102, random patches are extracted from the few retinal images and are labeled as one of the one or more gross pathologies by ophthalmologists. The labeled patches are used for the purpose of training the statistical models. For instance, patch 1 is extracted from a retinal image. The patch 1 is labeled as gross pathology 1 by the ophthalmologists. The patch 1 is used for training the disorder detection system 102. Further, when the disorder detection system 102, encounters a patch 2 similar to the patch 1, it may automatically classify the patch 2 as gross pathology 1. The disorder detection system 102 is trained using a vast set of images from the training data 205, comprising the one or more gross pathologies. Thereby, the disorder detection system 102 may be able to efficiently classify every patch into a corresponding one or more gross pathologies.

In an embodiment, gross pathology data 206 refers to a list of one or more gross pathologies which may be present in the one or more retinal images 101. The one or more gross pathologies may be categorized based on the type of the one or more retinal images 101. The type of the one or more retinal images 101 may be one of fundus image or an OCT scan. The list of one or more gross pathologies present in the fundus image are grouped into one of a dark lesions group and a bright lesions group. The one or more gross pathologies under the dark lesions group may be, but are not limited to, microaneurysms, vascular changes, preretinal haemorrhages and intraretinal hemorrhages. The one or more gross pathologies under the bright lesions group may be, but are not limited to, hard exudates, soft exudates, scars, neo-vascularization, fibrosis, drusen and laser scars.

In an embodiment, the list of one or more gross pathologies present in the OCT scans may be, but not limited to Fluid Filled Regions (FFR), hard exudates, Traction, Epiretinal Membrane (ERM), drusen and vitreomacular changes.

In an embodiment, the label data 207 refers to the set of labels associated with each of the one or more gross pathologies. In an embodiment each label of the set of labels may be a gross pathology by itself, i.e., each of the one or more gross pathologies may be associated with a label indicative of the corresponding gross pathology of the one or more gross pathologies. In an embodiment the gross pathology data 206 and the label data 207 may be inter-related.

In an embodiment, the label data 207 may comprise, but not limited to a first set of labels, second set of labels and a third set of labels. The first set of labels (or one or more gross pathologies) associated with the dark lesions group may be, but not limited to, microaneurysms, vascular changes, preretinal haemorrhages and intraretinal hemorrhages. The second set of labels (or one or more gross pathologies) associated with the bright lesions group may be, but not limited to, hard exudates, soft exudates, scars, neo-vascularization, fibrosis, drusen and laser scars. The third set of labels (or one or more gross pathologies) associated with the FFRs may be, but not limited to, cysts, sub-retinal fluid and neurosensory detachment.

In an embodiment, the image source data 208 refers to the source of the retinal image 101. The source of the one or more retinal images 101 may he at least one of fundus images and OCT scans. The image source data 208 may store information of source of each of the one or more retinal images 101.

In an embodiment, the image data 209 refers to the properties of each of the one or more retinal images 101. The properties may include, but are not limited to, resolution or quality of the one or more retinal images 101, sharpness of the one or more retinal images 101, image size, and image format. In an embodiment, when the one or more retinal images 101 are fundus images, the image data 209 may comprise information of one or more retinal images 101 whether the one or more retinal images 101 are peripheral images or macula centered images. In an embodiment, when the one or more retinal images 101 are OCT scans, the image data 209 may comprise information about one of presence and absence of fovea in each of the one or more retinal images 101.

In an embodiment, the other data 210 may include weighing parameters data, histogram data, feature vector data and disorder data. The weighing parameters data, refers to different parameters for assigning weight to each of the one or more retinal images 101. The weighing parameters data, is based on data present in the image source data 208 and the image data 209. Each of the one or more retinal images 101 is assigned a weight based on one or more parameters present in the weighing parameters data.

In an exemplary embodiment, if each of the one or more retinal images 101 is a macula centered image, the corresponding weight associated with the each of the one or more retinal images 101 may be 1. Likewise, if each of the one or more retinal images 101 is a peripheral image, the corresponding weight associated may be 0.8. The macula centered image contains optic disc and fovea (region of interests) and hence by the analysis of the macula centered image, the presence of disorder may he determined more accurately. The peripheral image, provides a peripheral view of the eye i.e., does not contain optic disc and fovea and therefore, peripheral image may have less impact on accuracy of analysis. Hence, macula centered image is given higher weightage as compared to the peripheral image

In an embodiment, if each of the one or more retinal images 101 is an OCT scan and is at a certain distance (for example 150 microns) from the fovea, the corresponding weight may be 1. If each of the one or more retinal images 101 is an OCT scan and is beyond the certain distance from the fovea, the corresponding weight may be 0.8.

In an embodiment, the histogram data may comprise of the histograms generated for each label of the set of labels.

In an embodiment, the feature vector data may comprise confidence vector generated for each of the one or more retinal images 101 and may also comprise the feature vector generated for the one or more retinal images 101.

In an embodiment, the disorder data refers to a list of disorders which may be determined, and grades associated with each of the disorders. The disorders may be, but are not limited to, Diabetic Retinopathy (DR), Age Related Macular Degeneration (ARMD), Retinal Vein Occlusions (RVO), optical disk changes, Diabetic Macular Edema (DME), Macular Edema due to vascular changes, Glaucoma. Further in an embodiment, DR may be correlated with DME. DME is an accumulation of fluid in the macula region of the retina. The subject, suffering from DR may develop DME. The presence of DME may be used to confirm, that the disorder is DR.

In an embodiment, the grades associated with DR may be one of mild DR, moderate DR, severe DR and proliferative DR. The grades may be indicative of the extent of effect caused by the disorder.

In an embodiment, the data 204 in the memory 202 is processed by modules 211 of the disorder detection system 102. As used herein, the term module may refer to an application specific integrated circuit (ASIC), an electronic circuit, a field-programmable gate arrays (FPGA), Programmable System-on-Chip (PSoC), a combinational logic circuit, and/or other suitable components that provide the described functionality. The modules 211 when configured with the functionality defined in the present disclosure will result in a novel hardware.

In one implementation, the modules 211 may include, for example, a communication module 212, a gross pathology identification module 213, a patch extraction module 214, a confidence value assigning module 215, a label classification module 216, a histogram generation module 217, a confidence vector generation module 218, a weight assignment module 219, a feature vector generation module 220, an analysis module 221 and other modules 222. It will he appreciated that such aforementioned modules 211 may be represented as a single module or a combination of different modules.

In an embodiment, the communication module 212 receives the one or more retinal images 101 from an image source, for processing the one or more retinal images 101 for detecting a disorder. The one or more retinal images 101 may be at least one of a fundus image and an OCT scan.

In an embodiment, the gross pathology identification module 213 may identify the one or more gross pathologies present in each of the one or more retinal images 101. The one or more gross pathologies may be identified in each of the one or more retinal images 101 using the training data 205. The gross pathology identification module 213, identifies at least one gross pathology of the one or more gross pathologies present in the gross pathology data 207.

In an embodiment, the patch extraction module 214 may extract one or more patches from each of the one or more retinal images, based on each of the one or more gross pathologies. In an embodiment, unlike conventional systems, the patch extraction module 214 may extract one or more patches centered around the one or more gross pathologies identified. The area of the one or more patches may be pre-defined. In an embodiment, area of the gross pathology may be considered as a patch and may be extracted. The one or more patches may be extracted using at least one of an image processing technique, pre-learnt statistical models, machine learning methods and rule based methods or any other method which may be used for extraction of patches.

In an embodiment, the confidence value assigning module 215 may comprise one or models corresponding to the one or more gross pathologies. The one or more models may be pre-trained statistical models. The confidence value assigning module 215 may include, but is not limited to, a bright lesion model, a dark lesion model, FFR model, hard exudate model, traction and ERM model. In an embodiment, the bright lesion model and the dark lesion model may be collectively represented as Fundus models in the present disclosure. In another embodiment, the FFR model, the hard exudate model, the traction and ERM model may be collectively represented as OCT models in the present disclosure. The bright lesion model may be associated with the bright lesions group of the gross pathology data 206. Similarly, the dark lesion model may be associated with the dark lesions group of the gross pathology data 206, and the OCT model may be associated with the one or more gross pathologies present in the OCT scans. The dark lesion model and the bright lesion model receive the one or more patches as input, extracted from the fundus images. Similarly, the OCT model receives the one or more patches as input, extracted from the OCT scan. Each model present in the confidence value assigning module 215 receives each of the one or more patches extracted from the corresponding one or more retinal images 101 as input. Each of the one or more models outputs a probability vector comprising a probability or a confidence value of the corresponding patch belonging to each label of the set of labels associated with the corresponding model. In an embodiment, the confidence value may have a range between 0 to 1.

In an embodiment, the label classification module 216 may classify each patch of the one or more patches into a label based on the probability vector. For a given patch, the label having the maximum confidence value in the probability vector is classified as the label for the corresponding patch.

In an embodiment, the histogram generation module 217 may generate a confidence histogram for each of the classified labels for the corresponding retinal image of the one or more one or more retinal images 101. The confidence histogram for each of the classified labels for the corresponding retinal image may he denoted as shown in Table 1 below.

TABLE 1

| | Confidence value ranges | | | | | | |
|---|---|---|---|---|---|---|---|
| Labels | 0-0.10 | 0.11-0.20 | 0.21-0.3 | 0.31-0.4 | . . . | 0.81-0.9 | 0.91-1 |

Label 1

Each of the one or more patches is associated with a confidence value for belonging to a particular label. For an instance, consider, 4 patches, Patch A, Patch B, Patch C and Patch D having confidence value of 0.3, 0.82, 0.9, 0.99 respectively for belonging to label 1. The confidence values may be divided into one or more intervals as shown in Table 1. The confidence value of each of the one or more patches fall in an interval of the one or more intervals of the confidence values. Number of patches in each interval are considered. Considering the above-mentioned instance, Patch A belongs to the interval 0.21-0.3, Patch B belongs to the interval 0.81-0.9, Patch C belongs to the interval 0.81-0.9, Patch D belongs to the interval 0.91-1, The confidence histogram for the above-mentioned instance is shown in Table 2 below.

TABLE 2

| | Confidence value ranges | | | | | | |
|---|---|---|---|---|---|---|---|
| Labels | 0-0.10 | 0.31-0.20 | 0.21-0.3 | 0.31-0.4 | . . . | 0.81-0.9 | 0.91-1 |
| Label 1 | 0 | 0 | 1 | 0 | 0 | 2 | 1 |

In an embodiment, the confidence vector generation module 218 may generate a confidence vector for each of the one or more one or more retinal images 101. The confidence vector may be generated by concatenating the confidence histogram generated for each classified label of the set of labels associated with the corresponding model. The confidence vector generated for corresponding retinal image of the one or more retinal images may indicate the probability of disorder in the corresponding retinal image.

In an embodiment, the weight assignment module 219 may assign weight to the confidence vector generated for each of the one or more one or more retinal images 101 based on the weighing parameters data. The confidence vector with corresponding weight may be considered as a weighted confidence vector. Alternatively, the weight assignment module 219 may assign weight to each of the one or more patches. The weight assigned to each of the one or more patches may be multiplied by the corresponding confidence values based on the weighing parameters data, to produce a weighted confidence value for the corresponding patch belonging to each label of the set of labels associated with the corresponding model.

In an embodiment, the feature vector generation module 220 may generate a feature vector by concatenating the weighted confidence vector generated for each of the one or more retinal images 101.

In an embodiment, the analysis module 221 may detect the presence of at least one disorder in the one or more retinal images 101. The at least one disorder is detected based on the feature vector generated by the feature vector generation module 220. The analysis module 221 computes a value of the feature vector by providing the feature vector as an input to a classifier. The classifier indicates a probability of presence of the at least one disorder and a grade of the at least one disorder.

In an embodiment, the other modules 222, may include, but are not limited to a grade classifier module, a report generation module and a notification module.

In an embodiment, the grade classifier module may classify the each of the one or more retinal images 101 into a grade present in the disorder data based on the value of the feature vector.

In an embodiment, the report generation module may be used to generate a report comprising details of the disorder detected by the disorder detection system 102. It may further indicate the grade of the disorder.

In an embodiment, the notification module may notify the detected disorder to a clinical specialist examining the one or more retinal images 101.

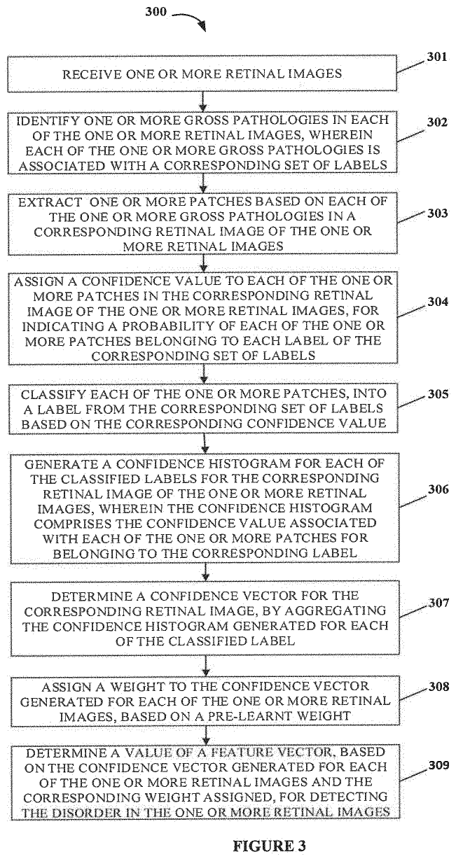

FIG. 3 shows an exemplary flow chart illustrating method steps of a method 300 for providing a response to a user input in accordance with some embodiments of the present disclosure.

As illustrated in FIG. 3, the method comprises one or more blocks for detecting disorders in retinal images. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 301, the one or more retinal images 101 are received by the communication module 212, from the image source, for processing the one or more retinal images 101 for detecting the disorder.

At step 302, one or more gross pathologies are identified in each of the one or more retinal images 101 by the gross pathology identification module 213. The one or more gross pathologies are identified using the training data 205. The gross pathology identification module 213, uses pre-trained statistical models or machine learning models which are trained to identify the one or more gross pathologies in retinal images based on the training data 205. Further, image processing techniques may be used to identify the one or more gross pathologies in the one or more retinal images 101.

At step 303, the one or more patches are extracted by the patch extraction module 214. The one or patches are extracted based on each of the one or more gross pathologies identified in step 302, in a corresponding retinal image of the one or more one or more retinal images 101. In an embodiment, the one or more patches present around the one or more gross pathologies may be extracted. Extraction of image patches may be performed using at least one of image processing techniques, pre-learnt statistical models, machine learning methods and rule based methods.

At step 304, a confidence value is assigned to each of the one or more patches in the corresponding retinal image of the one or more retinal images 101. The confidence value indicates a probability of each of the one or more patches belonging to each label of the corresponding set of labels. The pre-learnt statistical models, the Fundus models and the OCT models of the patch extraction module 214 are used for assigning the confidence value for each of the one or more patches. Each model outputs a probability vector comprising a probability or a confidence value of the corresponding patch belonging to each label of the set of labels associated with the corresponding model. Consider a first instance, where two fundus images are referred as image 1 and image 2. A first gross pathology is identified in image I and a second gross pathology is identified in the image 2. Consider that five patches namely, patch 1, patch 2, patch 3, patch 4 and patch 5 respectively are extracted from the image 1 based on the first gross pathology. Similarly, five patches patch 6, patch 7, patch 8, patch 9 and patch 10 are extracted from the image 2 based on the second gross pathology. Consider a model, model I which takes a patch as input and outputs confidence values of the patch belonging to each label of the model 1. Let model 1 comprise of 3 labels, namely label 1, label 2 and label 3. Consider that each of the five patches of image 1 and each of the five patches of image 2 are provided to model 1. The Table 3 represents the confidence values assigned by the model 1 to each patch.

TABLE 3

| Patches | Label 1 | Label 2 | Label 3 |
|---|---|---|---|
| Patch 1 | 0.2 | 0.7 | 0.1 |
| Patch 2 | 0.6 | 0.3 | 0.1 |
| Patch 3 | 0.6 | 0.2 | 0.2 |
| Patch 4 | 0.2 | 0.3 | 0.5 |
| Patch 5 | 0.9 | 0.05 | 0.05 |
| Patch 6 | 0.43 | 0.05 | 0.52 |
| Patch 7 | 0.25 | 0.25 | 0.5 |
| Patch 8 | 0.35 | 0.6 | 0.05 |
| Patch 9 | 0.05 | 0.15 | 0.8 |
| Patch 10 | 0.25 | 0.5 | 0.25 |

At step 305, each of the one or more patches, is classified by the label classification module 216 into a label from the corresponding set of labels based on the corresponding confidence value. A patch with corresponding maximum confidence value, for belonging to a label, is classified as belonging to the corresponding label. For instance, referring to Table 3, the patch 7 has a first confidence value of 0.25 of belonging to label 1, a second confidence value of 0.25 of belonging to label 2 and a third confidence value of 0.5 of belonging to label 3. The third confidence value is the maximal value and the corresponding label is label 3. Hence patch 7 is classified as label 3. Referring to the first instance, the below Table 4 represents the classification of each patch into a respective label and the corresponding confidence value.

TABLE 4

| Patches | Label | Confidence value |
|---|---|---|
| Patch 1 | Label 2 | 0.7 |
| Patch 2 | Label 1 | 0.6 |
| Patch 3 | Label 1 | 0.6 |
| Patch 4 | Label 3 | 0.5 |
| Patch 5 | Label 1 | 0.9 |
| Patch 6 | Label 3 | 0.52 |
| Patch 7 | Label 3 | 0.5 |
| Patch 8 | Label 2 | 0.6 |
| Patch 9 | Label 3 | 0.8 |
| Patch 10 | Label 2 | 0.5 |

At step 306, a confidence histogram is generated by the histogram generation module 217, for each of the classified labels for the corresponding retinal image of the one or more one or more retinal images 101. The confidence histogram comprises the confidence value associated with each of the one or more patches for belonging to the corresponding label. Referring to Table 3, the first instance and the Table 4, the confidence histogram for each label, for the image 1 may be represented as in the below table, Table 5.

TABLE 5

| | 0-1.0 | 0.11-0.2 | 0.21-0.3 | 0.31-0.4 | 0.41-0.5 | 0.5-0.6 | 0.61-0.7 | 0.71-0.8 | 0.81-0.9 | 0.91-1.0 |
|---|---|---|---|---|---|---|---|---|---|---|
| Label 1 | 0 | 0 | 0 | 0 | 0 | 0 | 2 | 0 | 0 | 1 |
| Label 2 | 0 | 0 | 0 | o | 0 | 0 | 0 | 1 | 0 | 0 |
| Label 3 | 0 | 0 | 0 | 0 | 0 | 1 | 0 | 0 | 0 | 0 |

Referring to the Table 1, first instance and the Table 4, the confidence histogram for each label, for the image 2 may be represented as in the below table, Table 6.

TABLE 6

| | 0-0.1 | 0.11-0.2 | 0.21-0.3 | 0.33-0.4 | 0.41-0.5 | 0.5-0.6 | 0.61-0.7 | 0.71-0.8 | 0.81-0.9 | 0.91-1.0 |
|---|---|---|---|---|---|---|---|---|---|---|
| Label 1 | 0 | 0 | 0 | 0 | 0 | 1 | 1 | 0 | 0 | 0 |
| Label 2 | 0 | 0 | 0 | 0 | 0 | 0 | 0 | 1 | 0 | 0 |
| Label 3 | 0 | 0 | 0 | 0 | 0 | 2 | 0 | 0 | 0 | 1 |

At step 307, a confidence vector is generated by the confidence vector generation module 218, for the corresponding retinal image, by concatenating the confidence histogram generated for each of the classified labels. In an embodiment, the confidence histogram generated for each of the classified labels may he truncated, to remove redundant values before concatenating each the confidence histogram generated for each of the classified labels. For example, referring to the Table 5 which shows a confidence histogram for the image 1. The Table 3 shows number of patches under each interval of the one or more intervals of confidence values for the corresponding label for the image 1. Likewise, Table 4 shows number of patches under each interval of the one or more intervals of confidence values for the corresponding label for the image 2. Further, a concatenation tool may concatenate, histograms of image 1 to generate a confidence vector for image 1. Referring to Table 3, the confidence histogram generated for label 1 is [0, 0, 0, 0, 0, 0, 2, 0, 0, 1]. Similarly, the confidence histogram generated for label 2 is [0, 0, 0, 0, 0, 0, 0, 1, 0, 0] and the confidence histogram generated for label 3 is [0, 0, 0, 0, 0, 1, 0, 0, 0, 0]. Further for truncating the histogram generated for each label let a threshold confidence value of 0.5 be considered. Thus, the patches having confidence values above the value of 0.5 for belonging to label 1, label 2 and label 3 are considered for generating the confidence vector for the image 1. The confidence vector for image 1 is represented as [0, 2, 0, 0, 1, 0, 0, 1, 0, 0, 1, 0, 0, 0, 0]. Likewise, a confidence vector is determined for image 2. The confidence vector for image 2 with a threshold confidence value of 0.5 may be represented as [1, 1, 0, 0, 0, 0, 0, 1, 0, 0, 2, 0, 0, 0, 1]. Similarly, the confidence vector may be determined for each of the one or more retinal images 101.

At step 308, a weight is assigned, by the weight assignment module 219, to the confidence vector generated for each of the one or more retinal images 101, based on the weighing parameters data. Each confidence vector may be multiplied with the corresponding weight assigned. Consider the first instance. If the image 1 is a macula centered image, the weight assigned to image 1 may be 1. If the image 2 is a peripheral image, the weight assigned to the image 2 may be 0.8 as mentioned in the weight parameters data.

Alternatively, the confidence value assigned for each patch of the one or more patches may he weighed to produce a weighted confidence value. The confidence value for each patch may be multiplied with the weight assigned to the corresponding retinal image of the one or more retinal images 101. The weighted confidence value for each patch of the one or more patches may be used to produce the confidence histogram.

At step 309, a feature vector is determined based on the confidence vector generated for each of the one or more retinal images 101 and the corresponding weight assigned. A weighted feature vector is determined by concatenating the weighted confidence vector of each of the one or more retinal images 101. The weighted feature vector is generated by the feature vector generation module 220 and the generated weighted feature vector is provided as an input to the analysis module 221.

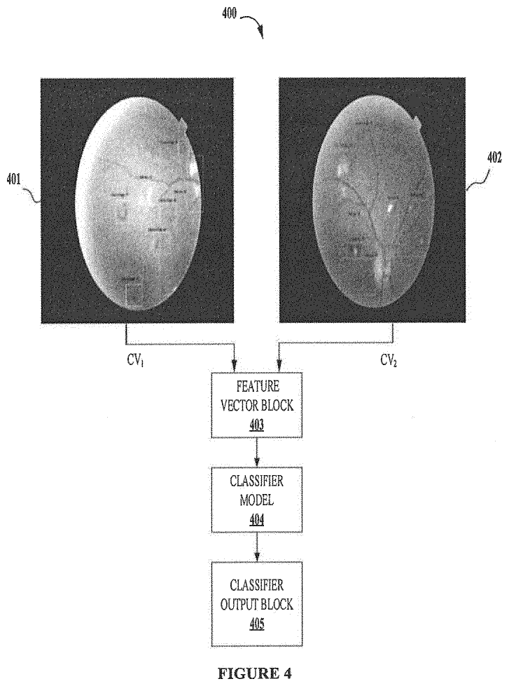

FIG. 4 shows exemplary representation of detecting disorders using two retinal images in accordance with some embodiments of the present disclosure. As illustrated, FIG. 4, comprises a fundus image 401, a fundus image 402, a feature vector block 403, a classifier model 404 and a classifier output block 405. The fundus image 401 is a peripheral fundus image and the weight assigned to fundus image 401 may be 0.8. The fundus image 402 is a macula centered fundus image and the weight assigned to fundus image 402 may be 1. Let CV₁ be the confidence vector generated for the fundus image 401 and let CV₂ be the confidence vector generated for the fundus image 402.

Let us assume, that for truncating the histogram generated for each label, a threshold confidence value of 0.9 is considered. The histogram generated for each label is truncated and the vector CV₁ is generated by concatenating the truncated histogram generated for each label. Let us assume, that the vector CV₁ comprises the values {0,2,2,0,4,0}. Likewise, let us assume that the vector CV₂ is generated for the fundus image 402 and comprises the values {3,3,0,0,1,0}. The vectors CV₁ and CV₂ are then given as input to the feature vector block 403. Further, the CV₁ is multiplied with a weight of 0.8 and CV₂ is multiplied with a weight of 1. A feature vector (FV) is generated using the equation 1:

FV=0.8*CV₁+1.0*CV₂ (1)

Let the FV generated using equation (1), comprise the values {3,4.6,0,0,4.2,0}. Further, the feature vector is given as an input to the classifier model 404. The classifier model 404 may be, but is not limited to, a random forest classifier, support vector machines etc. The classifier outputs a probability of each classification on the basis of the learning process the classifier has undergone. The classifier may be pre-trained to output a confidence on the grade of the disorder. The result obtained from the classifier output block 405 is as indicated in the below table, Table 7.

TABLE 7
Confidence on grades of disorder

| | |
|---|---|
| Mild DR | 0.06 |
| Moderate DR | 0.02 |
| Severe DR | 0.92 |
| Proliferative DR | 0.0 |

In an implementation, both fundus images and OCT scans may be analyzed. Consider an instance, where, two images image 3 and image 4 of the subject are considered. Image 3 may be a fundus image and a region of interest may be identified in the image 3. Further, the image 4 may be a OCT scan corresponding to the region of interest identified in the image 3. In order to detect the presence of DR, the ophthalmologist first analyzes the image 3 and may detect the presence of hemorrhages, microaneurysms, hard exudates. Further, the ophthalmologist analyzes the image 4 along with the image 3 and may detect presence of FFR, epiretinal membranes, thereby determining the presence of DME. Finally, the above-mentioned analysis results in qualifying the subject as suffering from DR with central/peripheral DME.

### Computer System

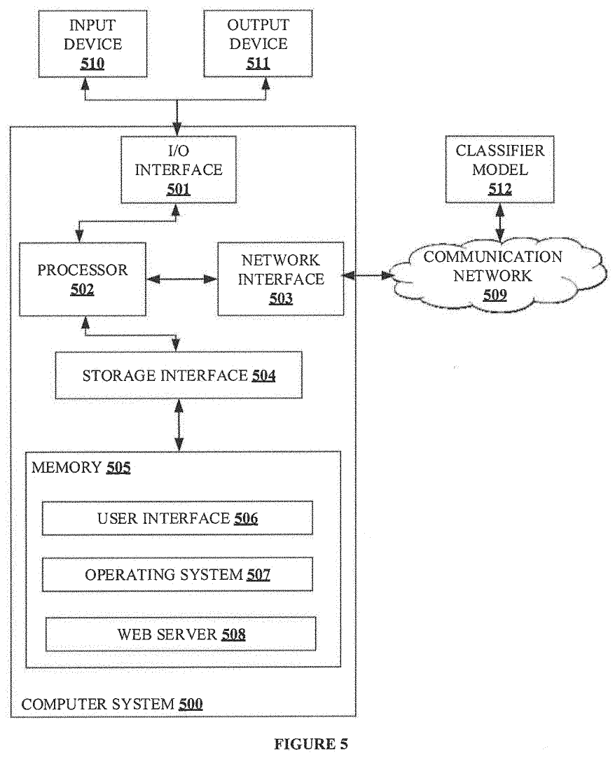

FIG. 5 illustrates a block diagram of an exemplary computer system 500 for implementing embodiments consistent with the present disclosure. In an embodiment, the computer system 500 is used to implement the disorder detection system 102. The computer system 500 may comprise a central processing unit (“CPU” or “processor”) 502,. The processor 502 may comprise at least one data processor for executing program components for detecting disorder in the one or more retinal images. The processor 502 may include specialized processing units such as integrated system (bus) controllers, memory management control units, floating point units, graphics processing units, digital signal processing units, etc.

The processor 502 may be disposed in communication with one or more input/output (I/O) devices (not shown) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices. For example, the input device 510 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 511 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 is connected to the classifier model 512 through a communication network 509. The classifier model 512 may be used for classifying the one or more retinal images into one of a presence and absence of disorder. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with the classifier model 512. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 509 includes, but is not limited to, a direct interconnection, an e-commerce network, a peer to peer (P2P) network, local area network (LAN), wide area network (WAN), wireless network (e,g,, using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of independent Discs (RAID), solid-state memory devices, solid-state drives, etc.

The memory 505 may store a collection of program or database components, including, without limitation, user interface 506, an operating system 507, web server 508 etc. In some embodiments, computer system 500 may store user/application data 506, such as, the data, variables, records, etc., as described in this disclosure. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 500 may implement a web browser 508 stored program component. The web browser 508 may be a hypertext viewing application, for example MICROSOFT® INTERNET EXPLORER™, GOOGLE® CHRONIC^{TM0}, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX™, DHTML™, ADOBE® FLASH™, JAVASCRIPT™, JAVA™, Application Programming Interfaces (APIs), etc. In some embodiments, the computer system 500 may implement a mail server stored program component. The mail server may be an Internet mail server such as Microsoft Exchange, or the like, The mail server may utilize facilities such as ASP™, ACTIVEX™, ANSI™ C++/C#, MICROSOFT®, .NET™, CGI SCRIPTS™, JAVA' JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 500 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Advantages of the embodiment of the present disclosure are illustrated herein.

Embodiments of the present disclosure perform analysis on a set of images of art eye of the subject to detect one or more disorders in the eye. A confidence histogram based methodology is employed to analyze multiple images (views) of the eye of the subject and determine the presence of the disorder.

Embodiments of the present disclosure are proficient of detecting disorder efficiently by analyzing both fundus images and OCT scans. The disclosed methodology can be used to combine and correlate the thndus images and OCT scans.

Embodiments of the present disclosure provide a dynamic technique of detecting disorders in the retinal images by using multiple gross pathology level labels rather than using patch based analysis.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Environment |
| 101 | Retinal Images |
| 102 | Disorder Detection System |
| 103 | Notification Unit |
| 201 | I/O Interface |
| 202 | Memory |
| 203 | Processor |
| 204 | Data |
| 205 | Training data |
| 206 | Gross Pathology data |
| 207 | Label data |
| 208 | Image source data |
| 209 | Image data |
| 210 | Other data |
| 211 | Modules |
| 212 | Communication module |
| 213 | Gross pathology identification module |
| 214 | Patch extraction module |
| 215 | Confidence value assigning module |
| 216 | Label classification module |
| 217 | Histogram generation module |
| 218 | Confidence vector generation module |
| 219 | Weight assignment module |
| 220 | Feature vector generation module |
| 221 | Analysis module |
| 222 | Other modules |
| 400 | Simulation results |
| 500 | Computer System |
| 501 | I/O Interface |
| 502 | Processor |
| 503 | Network Interface |
| 504 | Storage Interface |
| 505 | Memory |
| 506 | User Interface |
| 507 | Operating System |
| 508 | Web Server |
| 509 | Communication Network |
| 510 | Input Device |
| 511 | Output device |
| 512 | Classifier model |

We claim:

1. A method for detecting disorders in retinal images, comprising:
receiving, by a disorder detection system, one or more retinal images;
identifying, by the disorder detection system, one or more gross pathologies in each of the one or more retinal images, wherein each of the one or more gross pathologies is associated with a corresponding set of labels;
extracting, by the disorder detection system, one or more patches based on each of the one or more gross pathologies in a corresponding retinal image of the one or more retinal images;
assigning, by the disorder detection system, a confidence value to each of the one or more patches in the corresponding retinal image of the one or more retinal images, for indicating a probability of each of the one or more patches belonging to each label of the corresponding set of labels;
classifying, by the disorder detection system, each of the one or more patches, into a label from the corresponding set of labels based on the corresponding confidence value;
generating, by the disorder detection system, a confidence histogram for each of the classified labels for the corresponding retinal image of the one or more retinal images, wherein the confidence histogram comprises the confidence value associated with each of the one or more patches for belonging to the corresponding label;
determining, by the disorder detection system, a confidence vector for the corresponding retinal image, by concatenating the confidence histogram generated for each of the classified label;
assigning, by the disorder detection system, a weight to the confidence vector generated for each of the one or more retinal images, based on a pre-learnt weight;
determining, by the disorder detection system, a value of a feature vector, based on the confidence vector generated for each of the one or more retinal images and the corresponding weight assigned, for detecting the disorder in the one or more retinal images.

2. The method as claimed in claim 1, wherein the one or more gross pathologies are extracted from at least one of a fundus image and an Optical Coherence Tomography (OCT) scan.

3. The method as claimed in claim 2, wherein the one or more gross pathologies present in the fundus image are grouped into one of dark lesions and bright lesions.

4. The method as claimed in claim 2, wherein the one or more gross pathologies present in the OCT image are one of Fluid Filled Regions (FFR), hard exudates, traction, epiretinal membrane (ERM), drusen and vitreomacular changes.

5. The method as claimed in claim 3, wherein the bright lesions is associated with a first set of labels comprising at least one of hard exudates, soft exudates, scars, neo-vascularization, fibrosis, drusen and laser scars and wherein the dark lesions is associated with a second set of labels comprising at least one of microaneurysms, vascular changes, preretinal haemorrhages and intraretinal haemorrhages.

6. The method as claimed in claim 4, wherein the FFR is associated with a third set of labels comprising at least one of cysts, sub-retinal fluid and neurosensory detachment.

7. The method as claimed in claim 1, wherein the pre-learnt weight is calculated based on one of sharpness of the one or more retinal images, quality of the one or more retinal images and a presence of an optic disc in the one or more retinal images.

8. The method as claimed in claim 1, wherein determining the feature vector, further comprises:
combining, the confidence vector generated for each of the one or more retinal images and the corresponding weight assigned, to form a weighted confidence vector; and
concatenating, the weighted confidence vector, of each of the one or more retinal images to form the feature vector.

9. The method as claimed in claim 1, wherein the value of the feature vector indicates a probability of presence of the disorder and a grade of the disorder in the one or more retinal images.

10. A disorder detection system for detecting disorders in retinal images, said disorder detection system comprising:
a processor; and
a memory, communicatively coupled with the processor, storing processor executable instructions, which, on execution causes the processor to:
receive, one or more retinal images;
identify, one or more gross pathologies in each of the one or more retinal images, wherein each of the one or more gross pathologies is associated with a corresponding set of labels;
extract, one or more patches based on each of the one or more gross pathologies in a corresponding retinal image of the one or more retinal images;
assign, a confidence value to each of the one or more patches in the corresponding retinal image of the one or more retinal images, for indicating a probability of each of the one or more patches belonging to each label of the corresponding set of labels;
classify, each of the one or more patches, into a label from the corresponding set of labels based on the corresponding confidence value;
generate, a confidence histogram for each of the classified labels for the corresponding retinal image of the one or more retinal images, wherein the confidence histogram comprises the confidence value associated with each of the one or more patches for belonging to the corresponding label;
determine, a confidence vector for the corresponding retinal image, by concatenating the confidence histogram generated for each of the classified label;
assign, a weight to the confidence vector generated for each of the one or more retinal images, based on a pre-learnt weight;
determine, a value of a feature vector, based on the confidence vector generated for each of the one or more retinal images and the corresponding weight assigned, for detecting the disorder in the one or more retinal images.

11. The disorder detection system as claimed in claim 10, wherein the one or more gross pathologies are extracted from at least one of a fundus image and an Optical Coherence Tomography (OCT) image.

12. The disorder detection system as claimed in claim 11, wherein the one or more gross pathologies present in the fundus image are grouped into one of dark lesions and bright lesions.

13. The disorder detection system as claimed in claim 11, wherein the one or more gross pathologies present in the OCT image are one of Fluid Filled Regions (FFR), hard exudates, traction, epiretinal membrane (ERM), drusen and vitreomacular changes.

14. The disorder detection system as claimed in claim 12, wherein the bright lesions is associated with a first set of labels comprising at least one of hard exudates, soft exudates, scars, neo-vascularization, fibrosis, drusen and laser scars and wherein the dark lesions is associated with a second set of labels comprising at least one of microaneurysms, vascular changes, preretinal haemorrhages and intraretinal haemorrhages.

15. The disorder detection system as claimed in claim 13, wherein the FFR is associated with a third set of labels comprising at least one of cysts, sub-retinal fluid and neurosensory detachment.

16. The disorder detection system as claimed in claim 10, wherein the pre-learnt weight is calculated based on one of sharpness of the one or more retinal images, quality of the one or more retinal images and a presence of an optic disc in the one or more retinal images.

17. The disorder detection system as claimed in claim 10, wherein determining the feature vector, further comprises:
combining, the confidence vector generated for each of the one or more retinal images and the corresponding weight assigned, to form a weighted confidence vector; and
concatenating, the weighted confidence vector, of each of the one or more retinal images to form the feature vector.

18. The disorder detection system as claimed in claim 10, wherein the value of the feature vector indicates a probability of presence of the disorder and a grade of the disorder in the one or more retinal images.
